(19) United States
(12) Patent Application Publication
(10) Pub. No.: US 2023/0063444 A1
(43) Pub. Date: Mar. 2, 2023

(54) SPRAY UNIT

(71) Applicant: BAYER AKTIENGESELLSCHAFT, Leverkusen (DE)

(72) Inventors: Malcolm FAERS, Düsseldorf (DE); Andrew Charles CHAPPLE, Langenfeld (DE); Walter MAYER, Wuppertal (DE)

(21) Appl. No.: 17/797,406

(22) PCT Filed: Jan. 28, 2021
(86) PCT No.: PCT/EP2021/051914

§ 371 Date: Aug. 3, 2022

(30) Foreign Application Priority Data
Feb. 5, 2020 (EP) 20155549.7
Sep. 23, 2020 (EP) 20197813.7

(51) Int. Cl. B05B 3/10; B05B 12/12; B05B 13/00; B05B 12/18; A01M 7/00; A01C 23/04; A01C 23/00

(52) U.S. Cl. CPC B05B 3/1085; B05B 12/126; B05B 13/005; B05B 12/18; A01M 7/005; A01C 23/047; A01M 7/0089; A01C 23/007; A01M 7/0028; B64C 39/024

(57) ABSTRACT

The invention relates to a spray unit comprising an axle (10), a disc (20), a liquid applicator (40) and a spray direction assembly (50). The disc is configured to spin about the axle centred on the centre of the disc. The liquid applicator is configured to apply liquid to a surface of the disc. The spray direction assembly partially surrounds the disc. The inner surface of the spray direction assembly is configured to modify the trajectory of all liquid that leaves the outer edge of the disc.

### FIELD OF THE INVENTION

The present invention relates to spray unit and to a vehicle having such a spray unit.

### BACKGROUND OF THE INVENTION

The general background of this invention is the application of pesticides to crops. The spray liquid must be atomised. This is typically done using hydraulic nozzles. A more sophisticated approach is to use spinning discs. When a vehicle spraying the pesticide is a drone or unmanned aerial vehicle (UAV), the dedicated spray technology needs to be carefully considered because it adds weight and has energy requirements. As such spinning discs have the potential to be effective atomisation systems for drone applications. This is because they have a general low energy requirement for generating droplets, and other components are compatible with battery-powered drones.

However, spinning discs have the feature that the spray sheet emerges horizontally in the plane of the disc and the spray sheet requires a method to direct it towards the target crop. This can be achieved by tilting the disc sideways and adding a shield to block the spray in unwanted directions. This however has the complexity of engineering an apparatus to collect and recycle the blocked spray (c.f., Micron Herbiflex 4; http://www.microngroup.com/agricultural/herbiflex-4). Furthermore, the output from the spinning disc is significantly reduced, requiring additional atomisation units to compensate.

In unmanned aerial vehicles (UAVs), this can be achieved by placing the spinning disc beneath a rotor such that the so-called downwash effect (wind generated by rotors) directs the spray sheet downwards towards the target crop. Similar air assistance for direction of the spray sheet can be applied to land-based vehicles, for example tractors and unmanned ground vehicles (UGVs), fitted with either spray booms or individual atomisation units. However, the combination of a spinning disc and rotor or similar air assistance produces a cone shaped spray pattern which results in uneven deposition on the target crop as the application vehicle travels across the target field. The deposition is higher at the edges and lower in the centre, resulting in an M shaped deposition. The deposition should be uniform across the swath and there is a need for a spinning disc atomisation device that can produce a directed spray sheet with a uniform deposition across the working width no matter how many spray units are placed on a sprayer.

### SUMMARY OF THE INVENTION

It would be advantageous to have improved means for the spraying of liquids such as those containing chemical and/or biological agricultural active ingredients.

The object of the present invention is solved with the subject matter of the independent claims, wherein further embodiments are incorporated in the dependent claims. It should be noted that the following described aspects and examples of the invention apply also for the spray unit, the vehicle having one or more spray unit.

In a first aspect, there is provided a spray unit. The spray unit comprises an axle, a disc, a liquid applicator and a spray direction assembly. The disc is configured to spin about the axle centred on the centre of the disc. The liquid applicator is configured to apply liquid to a surface of the disc. The spray direction assembly partially surrounds the disc. The inner surface of the spray direction assembly is configured to modify the trajectory of all liquid that leaves the outer edge of the disc.

In other words, a spray unit with a spinning disc that contains a fixed hood that has a specific shape does direct the spray sheet into a fan shape instead of a hollow cone shape. The fixed hood surrounds the spinning disc in a configuration that allows it to capture and direct the atomised droplets from the spinning disc in the desired direction.

In this manner, the correct application of active ingredient per plant per unit area of land can be provided.

In an example, the spray direction assembly has a semi-spherical shape with opposing depending sidewalls and an aperture at the top region and an aperture at the bottom region.

In an example, the axle extends vertically through a central position of the aperture at the top region of the spray direction assembly.

In this manner, the spray direction assembly can be optimally positioned in relation to the spray axle and the spinning disc in order to maximize its influence on the trajectory of all liquid that leaves the outer edge of the disc.

In an example, the diameter of the aperture of the spray direction assembly at the bottom region is larger than the diameter of the aperture at the top region of the spray direction assembly.

In an example, the edge of the disc is located proximate to the inner surface of the spray direction assembly and proximate to the top region of the spray direction assembly.

In this way, the spray direction assembly does directly influence the trajectory of all liquid that leaves the disc without the possibility that any adverse effects can occur e.g. regarding the droplet size structure or distribution etc.

In an example, the shortest distance between the edge of the disc and the inner surface of the spray direction assembly is between 100 microns and 1 mm.

In an example, the spray direction assembly the inner surface in proximity to the aperture at the bottom region of the spray direction assembly through which the liquid leaves the spray direction assembly is disposed at an angle relative to the plane of the surface of the disc.

In this way, it's possible to run the spinning disc in a horizontal position and to optimally use the influence of centrifugal force to atomise the liquid. Nevertheless, with the spray direction assembly the atomised liquid can be directed towards the target area and/or crop which needs to be sprayed which is normally is disposed at an angle relative to the horizontal position of the spinning disc.

In an example, the inner surface of the spray direction assembly comprises a plurality of walls wherein the direction of the plurality of walls extends in a plane substantially perpendicular relative to the lateral side of the disc and further wherein the plane(s) of the plurality of walls are substantially perpendicular relative to the plane of the surface of the disc.

In this manner, channels or grooves are created as part of the spray direction assembly which aid the targeted distribution of the spray droplets.

In an example, the plurality of walls are located radially around the disc and preferably at equal distances around the disc.

In an example, the spray direction assembly has a circular aperture at the top region and an oval shaped aperture at the bottom region.

In other words, the oval shaped aperture at the bottom region of the spray direction assembly assists in achieving a flat fan like spraying pattern.

In an example, the inner surface of the spray direction assembly has a low friction surface.

In this way, the individual droplets formed from the rotating disc roll across the inner surface of the spray direction assembly and do not adhere significantly.

In an example, the ratio between the diameter of the disc relative to the greatest diameter of the aperture of the spray direction assembly at the bottom region is between 1:2 and 1:20.

In an example, the spray direction assembly is double-walled and the space between the two walls of the spray direction assembly is configured to channel air towards the spraying direction.

In other words, an air curtain within the fixed hood assists in the transport of the spray sheet to the target area and/or crop and penetration into the leaf canopy. This is especially appropriate at low spray volumes (e.g., <50 1/ha) where the lower momentum of the spray droplets and cloud reduces penetration of the droplets into the crop canopy. The air curtain can also be used to mitigate potential drift issues due to wind.

In a second aspect, there is provided a spray vehicle, comprising at least one spray unit according to the first aspect.

In an example, the spray vehicle comprises a liquid tank, a spray unit with a spray direction assembly configured to channel air towards the spraying direction, at least one actuator, a plurality of sensors and a processing unit. The liquid tank is configured to hold a liquid. The at least one spray unit is configured to spray a liquid. The at least one actuator is configured to control the air flow through the space of the spray direction assembly towards the spraying direction. At least one sensor of the plurality of sensors is configured to measure a speed of the spray vehicle relative to the ground. At least one sensor of the plurality of sensors is configured to measure an air movement direction relative to the spray vehicle with respect to a fore-aft axis of the spray vehicle. At least one sensor of the plurality of sensors is configured to measure an air movement speed relative to the spray vehicle. The processing unit is configured to determine an air movement direction relative to a projection of the fore-aft axis onto the ground and determine an air movement speed relative to the ground, the determination comprising utilisation of the speed of the spray vehicle, the air movement direction relative to the spray vehicle with respect to the fore-aft axis of the spray vehicle and the air movement speed relative to the spray vehicle. The processing unit is configured to control the at least one actuator, wherein determination of at least one instruction for the control the at least one actuator comprises utilisation of the determined air movement direction relative to the projection of the fore-aft axis onto the ground and the determined air movement speed relative to the ground.

In other words, the air curtain is designed in such a way that the air flow is adjusted to address changing wind conditions on the area to be sprayed, e.g. in order to mitigate potential drift.

Advantageously, the benefits provided by any of the above aspects equally apply to all of the other aspects and vice versa.

The above aspects and examples will become apparent from and be elucidated with reference to the embodiments described hereinafter.

### BRIEF DESCRIPTION OF THE DRAWINGS

Exemplary embodiments will be described in the following with reference to the following drawings:

FIG. 1 shows a schematic setup of an example of a newly developed spray unit from a side view perspective;

FIG. 2 shows the example of the spray unit according to FIG. 1 from another side view perspective;

FIG. 3 shows the example of the spray unit according to FIG. 1 with a plurality of walls on the inner side of the spray direction assembly from a side view perspective;

FIG. 4 shows the example of the spray unit according to FIG. 3 with a plurality of walls on the inner side of the spray direction assembly from an underside view perspective;

FIG. 5 shows the example of the spray unit according to FIG. 1 from an underside view perspective;

FIG. 6 shows the example of the spray unit according to FIG. 1 with an air channel in the spray direction assembly;

FIG. 7 shows the example of the spray unit according to FIG. 1 with a cone shaped disc;

FIG. 8 shows a schematic example of a spray vehicle with a spray unit.

FIG. 9 shows a schematic example of spray vehicles with different spray units and their corresponding spray swaths.

FIG. 10 shows a schematic example of a spray vehicle with a spray unit and the control of the air flow through the spray direction assembly.

FIGS. 11a and 11b each show a schematic example of a spray vehicle with a spray unit and the control of the air flow through the spray direction assembly as a function of different wind conditions.

### DETAILED DESCRIPTION OF EMBODIMENTS

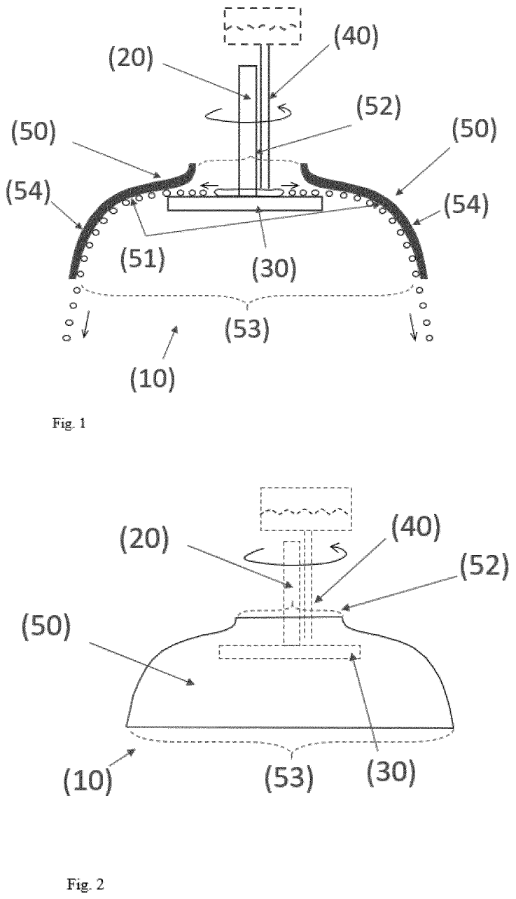

FIG. 1 shows an example of a spray unit 10 from a side view perspective. The spray unit comprises an axle 20, a disc 30, a liquid applicator 40 and a spray direction assembly 50. The disc is configured to spin about the axle centred on the centre of the disc. The liquid applicator is configured to apply liquid to a surface of the disc. The spray direction assembly partially surrounds the disc. The inner surface 51 of the spray direction assembly is configured to modify the trajectory of all liquid that leaves the outer edge of the disc.

In this manner, the spray direction assembly of the spray unit does direct the spray sheet into a fan shape instead of a hollow cone shape. The fixed hood surrounds the spinning disc in a configuration that allows it to capture and direct the atomised droplets from the spinning disc in the desired direction. As a result, the correct application of active ingredient per plat per unit area of land can be more easily provided.

In an example, the term “disc” refers to a flat disc but also includes cone shaped discs.

In an example, the disc comprises teeth or serrations set into the periphery of the disc.

In an example, the term “partially surrounds” indicates that the spray direction assembly has such a design and shape that at least all liquid that leaves the outer edge of the disc are modified in their trajectory. However, as the spray direction assembly has apertures it only partially surrounds the disc.

In an example, the spray direction assembly does not spin about the axle centred on the centre of the disc. In other words, the spray assembly is at a fixed position relative to the disc that is configured to spin about the axle centred on the centre of the disc.

In an example, the liquid applicator comprises at least one feed pipe. The feed pipe is configured to transfer liquid from a liquid tank to the disc and to apply the liquid on the disc.

In an example, the liquid applicator comprises at least one liquid tank and at least one feed pipe.

In an example, the spray direction assembly has an outer surface (54).

In an example, the term “liquid(s)” refer(s) to liquid(s) comprising chemical and/or biological based agricultural active ingredients such as e.g. herbicides, insecticides, fungicides, crop nutritional agents, biostimulants, plant growth regulators etc. In an example, the arrow close to the axle indicates a potential rotation direction of the axle and the disc. The rotation can also be clockwise.

In an example, the arrows above the plane surface of the disc indicate the direction of the centrifugal force and the atomisation of the liquid.

According to an example, the spray direction assembly has a semi-spherical shape with opposing depending sidewalls and an aperture 52 at the top region and an aperture 53 at the bottom region.

The term “semi-spherical” is intended to include shapes other than merely true spheres, including by way of example semi-spheroidal or semi-ellipsoidal such as e.g. semi-prolate or semi-oblate shapes. For example, the shape may comprise multiple surfaces that vary in the degree to which they are rounded. In such embodiments, minor discontinuities may exist where two or more such surfaces meet.

In an example the spray direction assembly has a semi-spheroidal shape.

In an example, the terms “top region” and “bottom region” refer to geographical positions relative to the ground, wherein the “bottom region” is closer to the ground in comparison to the “top region”.

According to an example, the axle extends vertically through a central position of the aperture at the top region of the spray direction assembly.

In an example, the feed pipe of the liquid applicator extends through the aperture at the top region of the spray direction assembly.

According to an example, the diameter of the aperture of the spray direction assembly at the bottom region is larger than the diameter of the aperture at the top region of the spray direction assembly.

In an example, the aperture at the bottom region has a circular a or oval cross-section. The spray swath of the atomized liquid leaving the aperatured at the bottom region towards the targeted crop and/or area has the same or similar cross-section as the aperture at the bottom region (and is therefore also circular or oval).

According to an example, the edge of the disc is located proximate to the inner surface of the spray direction assembly and proximate to the top region of the spray direction assembly.

In an example, the ratio of the distance between the disc and the aperture of the spray direction assembly at the top region and the distance between the disc and the aperture of the spray direction assembly at the bottom region is between 1:2 to 1:20, preferably 1:3:1:10.

According to an example, the shortest distance between the edge of the disc and the inner surface of the spray direction assembly is between 100 microns and 1 mm, more preferably between 150 microns and 500 microns.

According to an example, the inner surface in proximity to the aperture at the bottom region of the spray direction assembly through which the liquid leaves the spray direction assembly is disposed at an angle relative to the plane of the surface of the disc.

In other words, the liquid from the disc impinges on the inner surface of the spray direction assembly. At the aperture on the bottom region the atomised liquid leaves the spray direction assembly after downwardly sloping the inner surface of the spray direction assembly. The direction of the atomised liquid is steered by the spatial design of the inner surface at the lower part of the spray direction assembly. The leaving direction of the atomised liquid towards the targeted crop and/or area is disposed at an angle relative to the plane of the surface of the disc.

In an example, the spray direction assembly is disposed at a substantially perpendicular angle relative to the plane of the surface of the disc. The term “substantially perpendicular” in this context refers to an angle of 90°±50, preferably 90°±30°, more preferably 90°±20° and most preferably 90°±10°.

In an example, the arrows next to the atomised liquid leaving the spray direction assembly in FIG. 1 indicate an example of a possible direction of the leaving atomised liquid relative to the horizontal surface of the disc.

In an example, the arrow near the axle indicates a possible rotation direction of the axle. The rotation can also be clockwise.

In an example, the arrows above the disc indicate the direction of the centrifugal force of the disc and the atomisation direction of the liquid.

It is noted that “atomised” does not mean individual atoms, but relates to the standard use of this term with respect to spray systems, meaning a fine mist of particles that can range in sizes.

FIG. 2 shows the example of the spray unit 10 according to FIG. 1 from another side view perspective. The spray direction assembly 50 partially surrounds the disc 30 and has an aperture 52 at the top region for the axle 20 and the liquid applicator 40. The spray direction assembly 50 has also an aperture 53 at the bottom region where the atomised liquid leaves the spray unit. The arrow in FIG. 2 near the axle indicates a possible rotation direction of the axle. The rotation can also be clockwise.

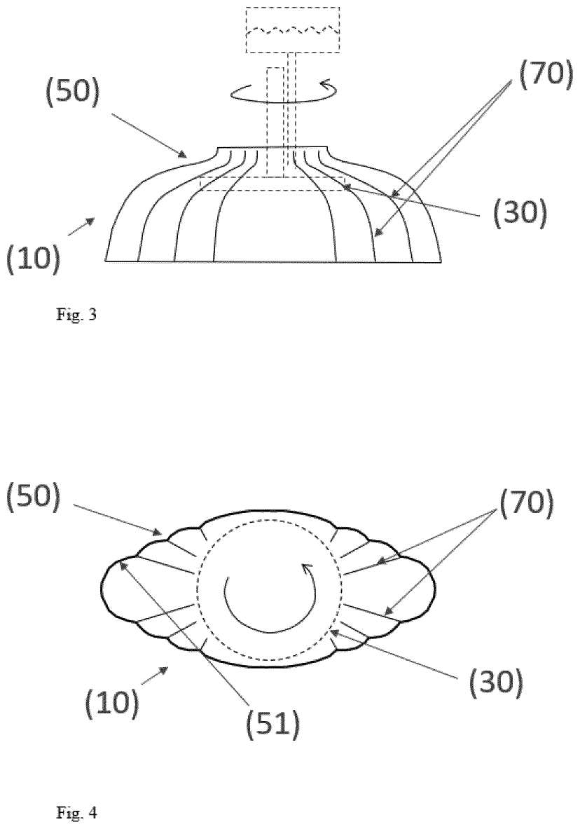

FIG. 3 shows the example of the spray unit 10 according to FIG. 1 with a plurality of walls 70 on the inner side of the spray direction assembly 50. The inner surface 51 (the number is not indicated in the figure) of the spray direction assembly comprises a plurality of walls wherein the direction of the plurality of walls extends in a plane substantially perpendicular relative to the lateral side of the disc and further wherein the plane of the plurality of walls are substantially perpendicular relative to the plane of the surface of the disc 30.

In an example, the term “substantially perpendicular” in the context of the direction of the plurality of walls relative to the lateral side of the disc refers to an angle of 90°±40°, preferably 90°±30°, more preferably 90°±20°.

In an example, the term “substantially perpendicular” in the context of the plane(s) of the plurality of the walls relative to the plane of the surface of the disc refers to an angle of 90°±30°, preferably 90°±20°, more preferably 90°±10°.

According to an example, the plurality of walls are located radially around (circumferentially) the disc and preferably at equal distances from each other around the disc.

The arrow in FIG. 3 indicates a possible rotation direction of the axle. The rotation can also be clockwise.

FIG. 4 shows the example of the spray unit 10 according to FIG. 3 with a plurality of walls 70 on the inner side of the spray direction assembly 50 from an underside view perspective. The disc 30 is shown through the aperture 53 (the number is not indicated in the figure) from underneath. The disc is partially surrounded by the spray direction assembly. The inner surface 51 of the spray direction assembly comprises a plurality of walls wherein the direction of the plurality of walls extends in a plane substantially perpendicular relative to the lateral side of the disc and further wherein the plane of the plurality of walls are substantially perpendicular relative to the plane of the surface of the disc.

In an example, the plane surface of the disc refers to the plane circular section where the liquid impinges from the liquid applicator on the disc and where the centrifugal force of the spinning disc forces the liquid to atomise and where finally the atomised liquid leaves the disc at the periphery of the plane surface.

In an example, the arrow indicates a potential rotation direction of the spinning disc. The rotation direction can also be clockwise.

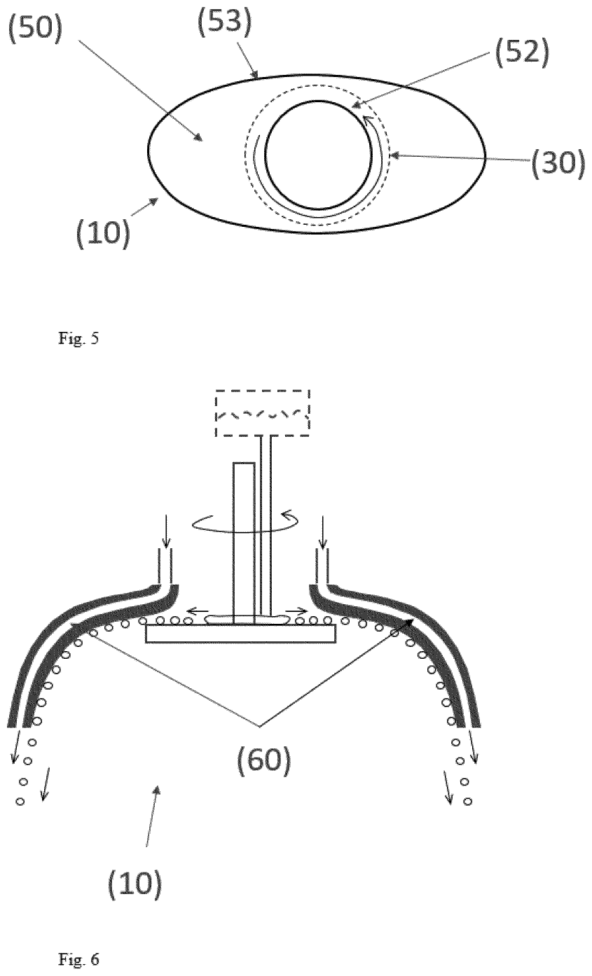

FIG. 5 shows the example of the spray unit 10 according to FIG. 1 from an underside view perspective. The disc 30 (dotted lines) is shown through the aperture 53 from underneath. The disc is partially surrounded by the spray direction assembly 50. The spray direction assembly has a circular aperture 52 at the top region and an oval shaped aperture 53 at the bottom region.

In an example, the arrow indicates a potential rotation direction of the spinning disc. The rotation direction can also be clockwise.

According to an example, the inner surface 51 of the spray direction assembly 50 has a low friction surface.

In an example, the inner surface of the spray direction assembly is hydrophobic.

The surface chemistry of the inner surface can be changed. For smooth surfaces, the surface adhesion of a spray liquid (either as a film, ligament or drop) can be changed in this way. For an aqueous liquid, a hydrophilic surface will have a higher adhesion with lower slip, while a hydrophobic surface will have a lower adhesion with higher slip (and vice versa for an oil). However, for smooth surfaces the range of adhesions accessible is not high (as seen by the narrow contact angle range).

In an example, the inner surface of the spray direction assembly is textured. The inner surface can e.g. comprise comb-like structures. As an example, 3D printing can be used to generate textured surface structures.

In an example, the size of the textured features is between 10 nm to 100 microns, preferably from 1 micron to 80 microns.

The range of adhesions (and contact angles) is significantly expanded for micro-textured surfaces. (More details are presented in the paper by Bico et al, Wetting of textured surfaces, Colloids and Surfaces A 206 (2002) 41-16).

In an example, the inner surface of the spray direction assembly has a contact angle with water>110°, preferably >120°.

In an example, the inner surface of the spray direction assembly is super-hydrophobic, preferably with a contact angle with water>150°.

It is known to the skilled person in the art that greater the angle the lower the adhesion. In an example, the inner surface of the spray direction assembly is configured to emit a cushion of air that keeps the droplets from contacting the inner surface. Recent advances in the wetting of textured surfaces has resulted in surfaces that are non-wetting to a wide range of liquids. (More details are presented in A Tuteja et al, Robust omniphobic surfaces, PNAS 105 (2008) 18200-18205, US 2019/0077968A1, US 2019/0039796A1, US 2015/0273518A1, https://en.wikipedia.org/wiki/LiquiGlide). Such surfaces can also be used for the inner surface of the spray direction assembly.

According to an example, the ratio between the diameter of the disc 30 relative to the greatest diameter of the aperture 53 of the spray direction assembly 50 at the bottom region is between 1:2 and 1:20, preferably between 1:4 to 1:10.

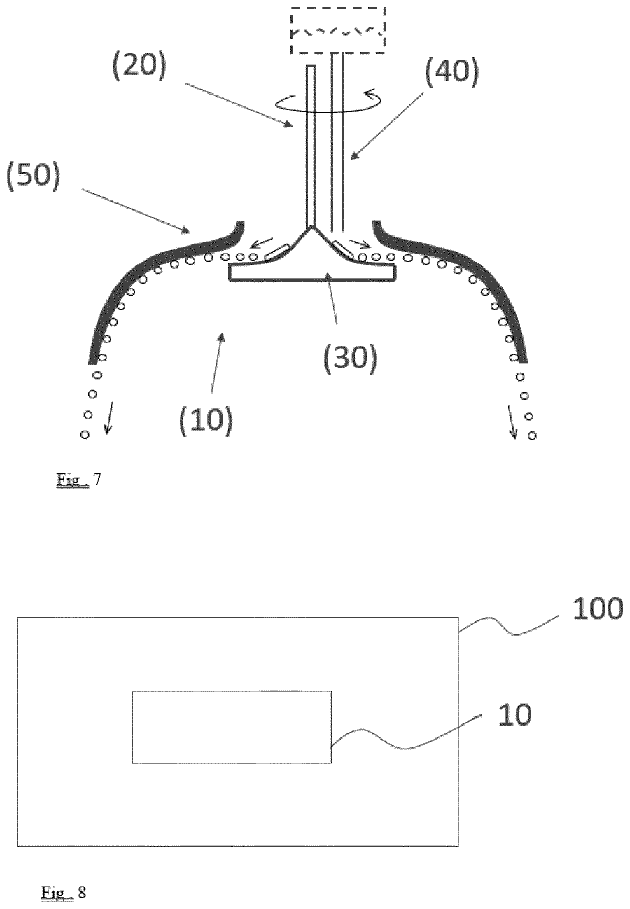

FIG. 6 shows the example of the spray unit 10 according to FIG. 1 with an air channel in the spray direction assembly. The spray unit 10 is like the spray unit discussed in FIG. 1 with the exception that the spray direction assembly is double-walled. The space 60 between the two walls of the spray direction assembly is configured to channel air towards the spraying direction.

In an example, the space 60 between the two walls is also referred to as one (or more) “air channel”.

In an example, the air stream is driven by a fan and flows through the space 60 from the top to the bottom region of the spray direction assembly.

In an example, the fan can be propellers e.g. of an UAV. The downward wind from the propellers is directed through the space 60 to the bottom region of the spray direction assembly. E.g. an actuator controls the air volume flow/time unit through the space 60.

It has to be noted that the air volume flow/time unit can be calculated by multiplying air velocity by the cross section area of the space/air channel for a certain time unit.

In an example, the inner surface of the spray direction assembly does comprise, preferably substantially uniformly distributed voids. The voids channel air towards the inner surface and produce a cushion of air that keeps the droplets that leave the disc from contacting the inner surface.

In an example, the arrows indicated in FIG. 6 have a similar meaning as discussed in the context of FIG. 1 with the exception that the arrows close to the space 60 indicate the air stream flowing direction from the top region to the bottom region of the spray direction assembly and then towards the spraying direction.

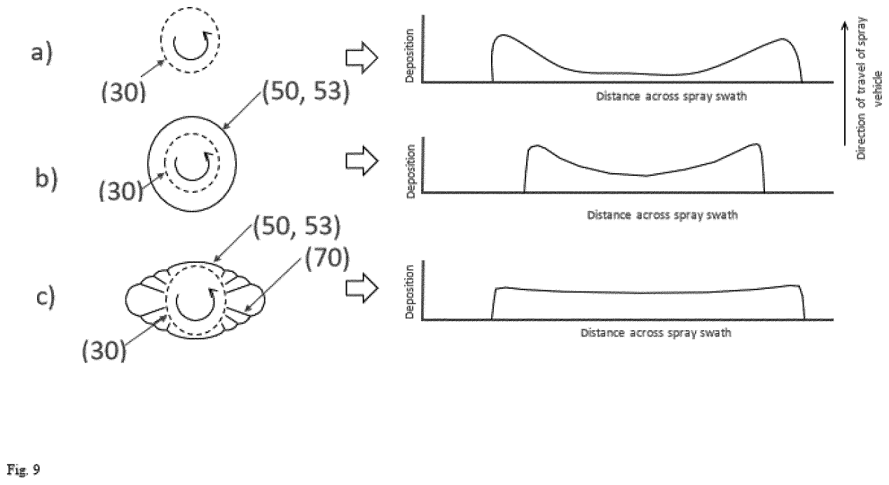

FIG. 7 shows the example of the spray unit 10 according to FIG. 1 with a cone shaped disc 30. The spray unit 10 comprises an axle 20, a cone shaped disc 30, a liquid applicator 40 and a spray direction assembly 50.

In an example, the arrows indicated in FIG. 7 have a similar meaning as discussed in the context of FIG. 1.

In an example, the spray unit can be used for boom sprayers, Unmanned Aerial Vehicles (UAVs), Unmanned Ground Vehicles (UGVs), robotics platforms and back-pack sprayers.

FIG. 8 shows a schematic example of a spray vehicle 100 with a spray unit 10 as described with respect to FIG. 1.

In an example, the vehicle is a drone or UAV.

In an example, the vehicle is a land vehicle such as an Unmanned Ground Vehicles (UGV), a robotic platform, tractor.

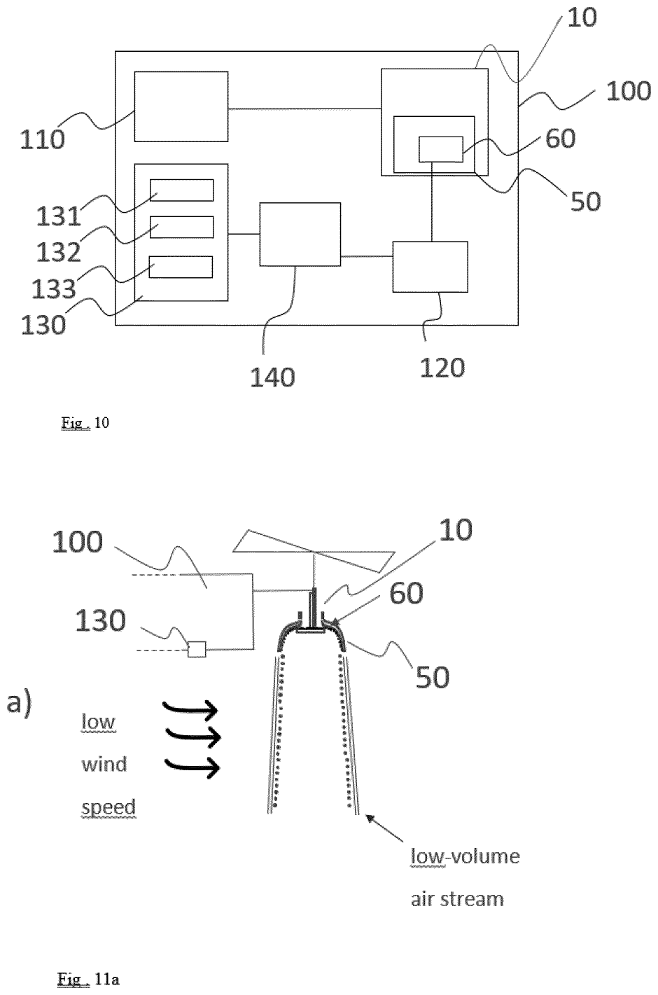

FIG. 9 shows a schematic example of spray vehicles with different spray units and their corresponding spray swaths. The spray vehicle in example a) does comprise a spray unit with a spinning disc 30 but no spray direction assembly. The spray swath deposition resulting from spraying with this spray vehicle is shown on the right and has a M-shape with a large distance across the spray swath. In example b), the spray vehicle does comprise a spinning disc 30 and a spray direction assembly 50 with a circular aperture 53 at the bottom region. Spraying with such a spray vehicle results in a spray swath that is more uniform in comparison to the spray swath as shown in example a). In example c), the spray vehicle does comprise a spinning disc 30 and a spray direction assembly 50 with an oval aperture 53 at the bottom region and a plurality of walls 70 at the inner surface. The spray swath is uniform across the whole distance of the spray swath. The arrows on the disc 30 in example a) to c) indicate the rotation direction of the disc which can also be clockwise.

FIG. 10 shows a schematic example of a spray vehicle 100 comprising a liquid tank 110, a spray unit 10 with a spray direction assembly 50 with a space (air channel) 60 configured to channel air towards the spraying direction, at least one actuator 120, a plurality of sensors 130 and a processing unit 140. The liquid tank is configured to hold a liquid. The at least one spray unit is configured to spray a liquid. The at least one actuator is configured to control the air flow through the space 60 of the spray direction assembly towards the spraying direction. The at least one sensor 131 of the plurality of sensors is configured to measure a speed of the spray vehicle relative to the ground. The at least one sensor 132 of the plurality of sensors is configured to measure an air movement direction relative to the spray vehicle with respect to a fore-aft axis of the spray vehicle. The at least one sensor 133 of the plurality of sensors is configured to measure an air movement speed relative to the spray vehicle. The processing unit is configured to determine an air movement direction relative to a projection of the fore-aft axis onto the ground and determine an air movement speed relative to the ground, the determination comprising utilisation of the speed of the spray vehicle, the air movement direction relative to the spray vehicle with respect to the fore-aft axis of the spray vehicle and the air movement speed relative to the spray vehicle. The processing unit is configured to control the at least one actuator, wherein determination of at least one instruction for the control the at least one actuator comprises utilisation of the determined air movement direction relative to the projection of the fore-aft axis onto the ground and the determined air movement speed relative to the ground.

In an example, the at least one sensor 131 configured to measure a speed of the spray vehicle relative to the ground comprises a GPS system.

In an example, the at least one sensor 131 configured to measure a speed of the spray vehicle relative to the ground comprises a laser reflectance based system.

In an example, the at least one sensor 132 configured to measure an air movement direction relative to the spray vehicle comprises a wind vane.

In an example, the at least one sensor 133 configured to measure an air movement speed relative to the spray vehicle comprises an anemometer.

In an example, the at least one sensor 133 configured to measure an air movement speed relative to the spray vehicle comprises a pitot tube.

In an example, the at least one sensor 132 and 133 configured to measure an air movement direction, speed (and distance) relative to the spray vehicle comprises a LIDAR sensor, preferably a Doppler LIDAR sensor.

In an example, “at least one actuator” refers to at least one mechanical device that converts energy into motion. The source of energy may be, for example, an electric current, hydraulic fluid pressure, pneumatic pressure, mechanical energy, thermal energy, or magnetic energy. For example, an electric motor assembly may be a type of actuator that converts electric current into a rotary motion, and may further convert the rotary motion into a linear motion to execute movement. In this way, an actuator may include a motor, gear, linkage, wheel, screw, pump, piston, switch, servo, or other element for converting one form of energy into motion.

In an example, the “at least one actuator” refers to at least one mechanical device that controls the air flow through the space 60 and the air volume flow is generated by UAV propellers.

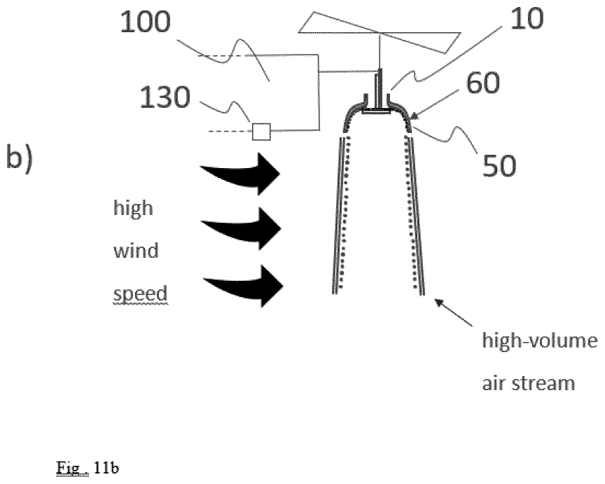

FIGS. 11a and 11b each show a schematic example of a spray vehicle 100 with a spray unit 10 and the control of the air flow through the spray direction assembly 50 as a function of different wind conditions. In this example, the spray vehicle is a UAV and does comprise at least one spray unit located beneath a propeller unit of the UAV. The spray unit does comprise a spray direction assembly 50 with a space 60 between the two walls of the spray direction assembly configured to channel air towards the spraying direction. The plurality of sensors 130 sense—among others—the direction and speed of the air movement (wind). The processing unit (not shown) uses the sensed information in order to instruct the at least one actuator (not shown) to control the air flow through the space of the spray direction assembly towards the spraying direction. In the example of FIG. 11a) the wind has a low wind speed and therefore a low-volume air stream flows through the space of the spray direction assembly towards the spray direction. In example of FIG. 11b) the wind has a high wind speed and therefore a high-volume air stream flows through the space of the spray direction assembly towards the spray direction.

It has to be noted that embodiments of the invention are described with reference to different subject matters. In particular, some embodiments are described with reference to spray unit type claims whereas other embodiments are described with reference to spray vehicle type claims. However, a person skilled in the art will gather from the above and the following description that, unless otherwise notified, in addition to any combination of features belonging to one type of subject matter also any combination between features relating to different subject matters is considered to be disclosed with this application. However, all features can be combined providing synergetic effects that are more than the simple summation of the features.

While the invention has been illustrated and described in detail in the drawings and foregoing description, such illustration and description are to be considered illustrative or exemplary and not restrictive. The invention is not limited to the disclosed embodiments. Other variations to the disclosed embodiments can be understood and effected by those skilled in the art in practicing a claimed invention, from a study of the drawings, the disclosure, and the dependent claims.

In the claims, the word “comprising” does not exclude other elements or steps, and the indefinite article “a” or “an” does not exclude a plurality. A single processor or other unit may fulfill the functions of several items re-cited in the claims. The mere fact that certain measures are re-cited in mutually different dependent claims does not indicate that a combination of these measures cannot be used to advantage. Any reference signs in the claims should not be construed as limiting the scope.

What is claimed is:

1. A spray unit, comprising:
an axle;
a disc;
a liquid applicator; and
a spray direction assembly;
wherein, the disc is configured to spin about the axle centred on a center of the disc;
wherein, the liquid applicator is configured to apply liquid to a surface of the disc; and
wherein the spray direction assembly partially surrounds the disc and wherein an interior surface of the spray direction assembly is configured to modify a trajectory of all liquid that leaves an outer edge of the disc.

2. The spray unit according to claim 1, wherein the spray direction assembly has a semi-spherical shape with opposing depending sidewalls and an aperture at a top region and an aperture at a bottom region.

3. The spray unit according to claim 2, wherein the axle extends vertically through a central position of the aperture at the top region of the spray direction assembly.

4. The spray unit according to claim 2, wherein a diameter of the aperture of the spray direction assembly at the bottom region is larger than a diameter of the aperture at the top region of the spray direction assembly.

5. The spray unit according to claim 1, wherein the edge of the disc is located proximate to the interior inner surface of the spray direction assembly and proximate to a top region of the spray direction assembly.

6. The spray unit according to claim 1, wherein a shortest distance between the edge of the disc and the interior surface of the spray direction assembly is between 100 microns and 1 mm.

7. The spray unit according to claim 1, wherein the interior inner surface is in proximity to an aperture at a bottom region of the spray direction assembly through which the liquid leaves the spray direction assembly and wherein the interior surface is disposed at an angle relative to a plane of the surface of the disc.

8. The spray unit according to claim 1, wherein the interior inner surface of the spray direction assembly comprises a plurality of walls wherein a direction of the plurality of walls extends in a plane substantially perpendicular relative to a lateral side of the disc and further wherein the plurality of walls are substantially perpendicular relative to a plane of the surface of the disc.

9. The spray unit according to claim 8, wherein the walls are located radially around the disc.

10. The spray unit according to claim 1, wherein the spray direction assembly has a circular aperture at a top region and an oval shaped aperture at a bottom region.

11. The spray unit according to claim 1, wherein the interior inner surface of the spray direction assembly has a low friction surface.

12. The spray unit according to claim 1, wherein a ratio between a diameter of the disc relative to a greatest diameter of an aperture of the spray direction assembly at a bottom region is between 1:2 and 1:20.

13. The spray unit according to claim 1, wherein the spray direction assembly is double-walled and wherein a space between the two walls of the spray direction assembly is configured to channel air towards the spraying direction.

14. A spray vehicle, comprising the spray unit according to claim 1.

15. The spray vehicle according to claim 14, further comprising:
a liquid tank;
at least one actuator;
a plurality of sensors; and
a processing unit;
wherein, the liquid tank is configured to hold the liquid;
wherein, the at least one spray unit is configured to spray the liquid;
wherein, the at least one actuator is configured to control air flow through a space (60) of the spray direction assembly towards the spraying direction;
wherein, at least one sensor of the plurality of sensors is configured to measure a speed of the spray vehicle relative to the ground;
wherein, at least one sensor of the plurality of sensors is configured to measure an air movement direction relative to the spray vehicle with respect to a fore-aft axis of the spray vehicle;
wherein, at least one sensor of the plurality of sensors is configured to measure an air movement speed relative to the spray vehicle;
wherein, the processing unit is configured to determine an air movement direction relative to a projection of the fore-aft axis onto the ground and determine an air movement speed relative to the ground, the determination comprising utilisation of the speed of the spray vehicle, the air movement direction relative to the spray vehicle with respect to the fore-aft axis of the spray vehicle and the air movement speed relative to the spray vehicle; and
wherein, the processing unit is configured to determine at least one instruction to control the at least one actuator, wherein determination of the at least one instruction for the control of the at least one actuator comprises utilisation of the determined air movement direction relative to the projection of the fore-aft axis onto the ground and the determined air movement speed relative to the ground.

16. The spray unit according to claim 9, wherein the walls are located at equal distances around the disc.
